(19) United States
(12) Patent Application Publication
(10) Pub. No.: US 2022/0309883 A1
(43) Pub. Date: Sep. 29, 2022

(54) MULTI-SPORT CHALLENGE SYSTEMS AND METHODS

(71) Applicant: West Flagler Associates, Ltd., Miami, FL (US)

(72) Inventor: Scott Savin, Miami, FL (US)

(73) Assignee: West Flagler Associates, Ltd., Miami, FL (US)

(21) Appl. No.: 17/215,637

(22) Filed: Mar. 29, 2021

(51) Int. Cl. G07F 17/38; G07F 17/32

(52) U.S. Cl. CPC G07F 17/38; G07F 17/3295; G07F 17/3262

(57) ABSTRACT

A multi-sport challenge system may include a multi-sport facility, a sport challenge menu including a plurality of selectable sport challenges, and a fee/prize subsystem. The multi-sport facility may include a plurality of sport grounds, wherein each of the sport grounds includes a full, partial, or simulated sport grounds. The sport challenge menu may include an entry fee and financial prize corresponding to each selectable sport challenge of the menu, wherein the entry fee is to be paid by a participant that selects the corresponding sport challenge for an opportunity to attempt the sport challenge. The financial prize may be awarded to the participant if the attempt successfully completes the sport challenge. The fee/prize subsystem may be configured to receive sport challenge selections made by participants and to collect the corresponding entry fees from the participants and output corresponding financial prizes upon successful completion of the selected sport challenges.

### TECHNOLOGY FIELD

The present disclosure is directed to multi-sport challenge systems and methods, more specifically multi-sport challenge systems and methods that combine multi-sport challenges with that include participant wagering.

### BACKGROUND

Sports offer enjoyment to participants as well as spectators and act to feed the innate competitive spirit. While the particular games and the athletic feats involved have changed, sport competitions have been a part of the human experience since recorded history. Indeed, early sports were found on every inhabited continent from the Mesoamerican ballgame in North America, boxing and archery in Africa, wrestling in Europe, to Cuju in China. Sports have been used as a learning tool for survival, physical development, coordination, team building, as well as for enjoyment and an outlet to escape our everyday lives.

Modern humans typically engage in sport during youth and then slowly reduce frequency of participation as they get older and the responsibility and physical decline of adulthood take hold. Commonly, adults seek their competitive sporting outlet as spectators of sport competitions participated in by others, such as younger individuals or those few adults who successfully overcame the odds to become professional athletes. Sometimes this outlet also manifests itself in participation in wagering on the outcomes or related components of the various sport competitions participated in by others. However, many adults still have a desire to compete and evidence their athletic skill in one or more sporting feats. Such adults may participate in recreational sports in their free time in order to hone their skills, but without pay and typically without accolades. What is needed are additional athletic outlets that allow adults to evidence their athletic skills without the barriers of being signed by a professional sport team.

### SUMMARY

In one aspect, a multi-sport challenge system may include a multi-sport facility, a sport challenge menu including a plurality of selectable sport challenges, and a fee/prize subsystem. The multi-sport facility may include a plurality of sport grounds, wherein each of the sport grounds includes a full, partial, or simulated sport grounds. The sport challenge menu may include an entry fee and financial prize corresponding to each selectable sport challenge of the menu, wherein the entry fee is to be paid by a participant that selects the corresponding sport challenge for an opportunity to attempt the sport challenge. The financial prize may be awarded to the participant if the attempt successfully completes the sport challenge. The fee/prize subsystem may be configured to receive sport challenge selections made by participants and to collect the corresponding entry fees from the participants and output corresponding financial prizes upon successful completion of the selected sport challenges.

In one example, the multi-sport facility includes one or more bowling lanes, par 3 golf hole, and a full or reduced size basketball court, football field, and baseball field. In a further example, the multi-sport facility further includes one or more sport simulators. The one or more sport simulators include a golf simulator, shooting range simulator, a soccer simulator, a baseball simulator, or combination thereof.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 schematically illustrates an exemplary multi-sport facility of a multi-sport challenge system according to various embodiments described herein;

FIG. 2 is a menu listing various sport challenges of an exemplary multi-sport challenge system according to various embodiments described herein; and

FIGS. 3A-3F show exemplary sport specific menus of a multi-sport challenge system according to various embodiments described herein.

### DESCRIPTION

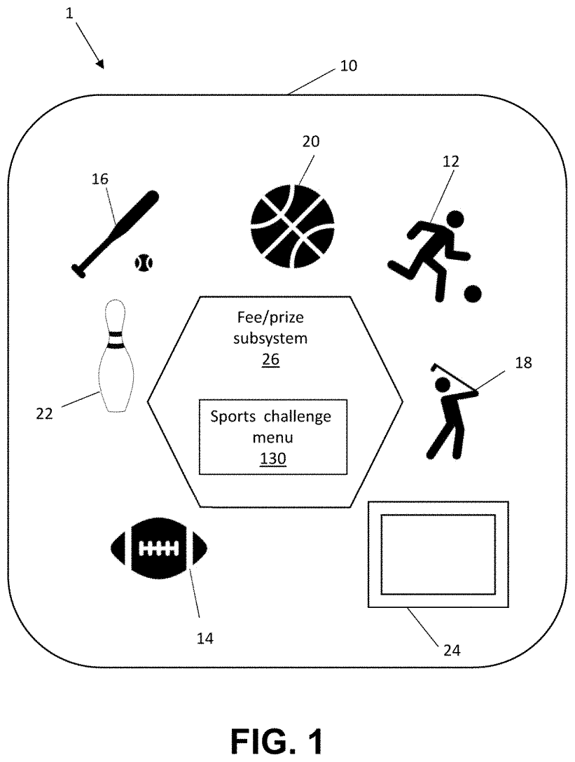

The present disclosure describes a multi-sport challenge system and methods of conducting multi-sport challenges. FIGS. 1-3F illustrate features of various embodiments of the multi-sport challenge system wherein like numbers reference like features.

With reference to FIG. 1, the multi-sport challenge system 1 may include a multi-sport facility 10 housing a plurality of sport grounds or portions thereof whereon participants may attempt various sport challenges. The sport grounds may include one or more fields such as a soccer field 12, football field 14, or baseball field 16, golf hole 18, one or more courts such as a basketball court 20, tennis court, or jai alai court, hockey rink, bowling lane 22, gym/weights, track, or the like. In one example, the facility may include a multi-sport complex including multiple sporting grounds selected from a bowling lane 22, a golf hole 20, e.g., a par 3 golf hole, basketball court 16, football field 14, baseball field 18, shooting range, and soccer field 12. Additional and/or alternate sport grounds may also be included.

In one embodiment, one or more of the sport grounds may be reduced in size. For example, the multi-sport facility 10 may include a reduced size soccer field 12 (e.g., goal, quarter field, half field), a reduced size football field 14 (e.g., goalposts/uprights and 20 to 50 or more yards of field), a reduced size baseball field 16 (e.g., an infield, an outfield, an infield and partial outfield, an outfield and partial infield, a pitcher's mound and home plate, or a wedge section of the field taken from home plate), and/or a reduced size basketball court 20 (e.g., half court).

In some embodiments, the multi-sport facility 10 may include alternative sport grounds comprising one or more sport simulators 24 in addition to or instead of one or more of the traditional sport grounds such as a golf simulator, shooting range simulator, soccer simulator, or baseball simulator. Simulators 24 typically use various tracking technology such as infrared or camera detection to track movements of the user and/or sport implement, e.g., body part, ball, puck, bat, club, gun, etc. Simulators 24 may also include display screens in which users may interact with respect to the sporting environment being simulated. Example simulators 24 may include golf simulators including launch monitors and/or simulation programs manufactured by Foresight Golf, LLC, Boerne, Tex.; TruGolf, Inc., Centerville, Utah; TrackMan, Inc., Stamford, Conn.; SkyTrak, LLC, Winston Salem, N.C.; or Full Swing Golf Inc., San Diego, Calif. Example simulators 24 for additional sports may include simulators 24 such as TRUGOLF™ Multisport Simulator (baseball, hockey, soccer, footgolf), manufactured by TruGolf, Inc. or Full Swing MultiSport Simulators manufactured by Full Swing Golf Inc., San Diego, Calif. (handgun or rifle shooting, baseball hitting or pitching, soccer kicking or goal shooting, football passing or kicking, basketball goal shooting, lacrosse goal shooting, hockey goal shooting, golf, among others).

In various embodiments, the multi-sport challenge system 1 includes the multi-sport facility 10 configured to provide a plurality of sport challenges with respect to the sport grounds available to participants in which an entry fee is paid for the opportunity to win a financial prize upon successful completion of one or more of the available sport challenges. For example, the multi-sport challenge system 1 may include 8 or more, such as greater than 10, greater than 12, greater than 15, greater than 20, or greater than 25 sport challenges that may be available to participants that all include an entry fee to win a financial prize comprising a specific dollar amount upon successful completion of an entered sport challenge. Such a multi-sport challenge system and facility may allow participants to pay entry fees for one or more selected challenges to win a pre-determined amount by successfully completing the sport challenge. An entry fee may provide the participant a single attempt to successfully complete a specified sport challenge to receive the financial prize. As described in more detail below, various embodiments may include enhancers that increase relative difficulty of the sport challenge, e.g., multiple successful attempts, greater distance or speed, smaller target, etc.

The multi-sport challenge system 1 may include a fee/prize subsystem 26 configured to receive entry fees for the various sport challenges and distribute financial prizes upon successful completion of sport challenges subject to the entry fee. In some embodiments, the fee/prize subsystem 26 may include a physical building or structure within the multi-sport facility 10 where participants may select sport challenges, pay entry fees, and receive financial prizes upon successful completion of sport challenges. As described in more detail below, in one embodiment, the fee/prize subsystem 26 may be partially or substantially automated. For example, the fee/prize subsystem 26 may include a processor and memory storing instructions executable by the processor for performing the operations of the fee/prize subsystem 26.

As introduced above, the multi-sport challenge system may incorporate various sport challenges. Participants may compete in the sport challenges at the multi-sport facility on full or modified sized fields, courts, grounds, etc. and/or simulators.

In various embodiments, the multi-sport challenge system includes soccer related sport challenges. Soccer related sport challenges may include scoring a penalty kick or corner kick goal against a goalie or hitting a target from a penalty line or corner; successfully blocking a shot on goal; performing a goal kick, e.g., an indirect free kick or dropped ball, and hitting a stationary or moving target, target area, or achieving a specified distance. Additional requirements of the soccer challenges or soccer challenge enhancers may include performing the challenge while applying a predetermined curvature on the ball, successful completion of a multiple or a specified soccer related sport challenge or multiple soccer related sport challenges, e.g., successful completion of a parlay of two or more of the sport challenges. The above or other soccer related sport challenges may be performed on a full or partial soccer field and/or utilizing a soccer simulator of the multi-sport facility.

In some embodiments, the multi-sport challenge system includes football related sport challenges. Football related sport challenges may include successfully kicking an extra point; kicking a field goal; passing a football and hitting a stationary or moving target or area; punting a football a specified distance and/or to a specified location; or catching a punt or kickoff Field goals, passing distances, or punting distances may include various distances such as 10 yards, 15 yards, 20 yards, 25 yards, 30 yards, 35 yards, 40 yards, 45 yards, 50 yards, or more. Additional requirements of the football related sport challenges or football related sport challenge enhancers may include successful completion of a multiple of a selected football related sports challenge, e.g., consecutively, or multiple football related sport challenges, e.g., successful completion of a parlay of two or more of the football related challenges. In one example, a football related sport challenge includes making multiple successful passing attempts or a specified number of successful throws to a target or target area. In one example, a football related sport challenge includes successfully kicking field goals from two or more distances or successfully hitting a target or target area in succession. The above or other football related sport challenges may be performed on a full or partial, e.g., 50 yard, football field and/or using a football simulator of the multi-sport facility.

In various embodiments, the multi-sport challenge system includes basketball related sport challenges. Basketball related sport challenges may include hitting one or more shots from one or more specified locations of a basketball court such as half-court, 3 point (e.g., top of the key, corner, or participant choice), or free throw. Additional requirements of the basketball related sport challenges or basketball related sport challenge enhancers may include hitting basketball shots in a specified manner, such as a swish, bank, no backboard, or successful completion of a multiple of a selected basketball related sport challenge or multiple basketball related sport challenges, e.g., successful completion of a parlay of two or more of the basketball related sport challenges. The above or other basketball related sport challenges may be performed on a full or partial, e.g., half-court, basketball court and/or using a basketball simulator of the multi-sport facility.

In some embodiment, the multi-sport challenge system includes baseball related sport challenges. Baseball related sport challenges may include participants utilizing a full or partial baseball field or simulator. Example baseball related sport challenges may include participants throwing a baseball from an outfield location, e.g., centerfield, and hitting a target at home plate; throwing out of a crouch from a home plate location and hitting a target at second base, throwing from an infield position and hitting a target at first base. In a further example, baseball related sport challenges may include or be enhanced to include fielding the ball before throwing at the target and/or hitting the target within a specified time from when the ball is mechanically or manually hit or thrown to the participant, e.g., from home plate or a pitcher's mound or hits the participant's mitt. Additional examples of baseball related sport challenges may include throwing a strike from a pitcher's mound or throwing a breaking ball having a predetermined distance or range of distance of break. The pitch may be required to be a strike, which may be an enhancer to increase the financial prize for successfully completing the challenge. Further examples, may include fielding a ground ball, catching a fly ball, hitting a grounder, popup, homerun, or line drive, or stealing a base or breaking for a base steal with enough time to beat a predetermined timed throw at a predetermined foot speed, or to a particular side of the field. In one configuration, a baseball related sport challenge or an enhancer to a hitting related sport challenge may require the participant to hit a baseball to a particular area of the field. In one example, baseball related sport challenges may include or be enhanced for successful completion of multiple baseball related sport challenges, e.g., successful completion of a parlay of two or more of the baseball related sport challenges. The above or other baseball related sport challenges may be performed on a full or partial baseball field and/or using a baseball simulator of the multi-sport facility.

In various embodiments, the multi-sport challenge system includes golf related sport challenges. Golf related sport challenges may include participants utilizing a golf hole, e.g., a par 3 hole, green, range, fairway, simulator, or the like. For example, participants may pay an entry fee for an opportunity to win a financial prize for landing a ball on a green; landing the ball on the green a particular distance from the hole; landing the ball on the green with a particular amount, direction, or range of roll; holing the ball. The multi-sport facility 10 may include a fairway or golf simulator wherein participants pay an entry fee for a sport challenge that includes achieving a 200, 250, 300, or 350 yard drive. In order for distance to be accepted, the ball may be required to land or ultimately come to rest in a fairway or other specified location, such as on a green area. In one example, location of rest may be available as an enhancer to increase the financial prize for successfully completing the sport challenge. Other golf related sport challenges may include accuracy or distance using other clubs such as irons, hybrids, or non-driving woods. In some examples, golf sport challenges may include imparting a draw or fade ball flight, which in some instances may be applied as an enhancer to a distance or accuracy based golf sport challenge. Additional requirements of golf related sport challenges or golf related sport challenge enhancers may include completion of a multiple of a specified challenge or multiple different golf related challenges, e.g., successful completion of a parlay of two or more of the golf related challenges. The above or other golf related sport challenges may be performed on a full or partial golf hole and/or using a golf simulator of the multi-sport facility.

In some embodiments, the multi-sport challenge system includes bowling related sport challenges. Example bowling related sport challenges may include achieving a number of strikes in a row, achieving a number of spares in a row, achieving a combination of strikes and/or spares in a row, achieving a specified combination or series of strikes and spares, achieving a particular pin combination knocked down or remaining, or successfully picking up a specified split, e.g., 7-10, 8-10, 3-7, 7-9, 4-6-7-10, 3-7-10, 3-10, 5-7, etc. Additional requirements of bowling related sport challenges or bowling related sport challenge enhancers may include performing the sport challenge while applying a specified curvature to the bowling ball or initiating the roll at a specified location or area of the lane, successful completion of a multiple of a selected bowling related sport challenge or multiple bowling related sport challenges, e.g., successful completion of a parlay of two or more of the bowling related challenges. The above or other bowling related sport challenges may be performed on a full or partial bowling lane and/or using a bowling simulator of the multi-sport facility.

In various embodiments, the multi-sport challenge system includes shooting related sport challenges. Example shooting related sport challenges may include striking a target with a projectile, e.g., bullet, dart, BB, pellet, paintball, or arrow, shot from a rifle, handgun, bow, or crossbow, for example. One or more targets may be set up. Targets may include traditional bullseye type targets or may include objects such as animal figures or locations identified on objects. Additional requirements of shooting related sport challenges or shooting related sport challenge enhancers may include time to aim and fire the projectile, successful completion of multiple hits to a target or multiple targets or locations within a target. Shooting related sport challenges or enhancers may include distances from the target the participant must shot from and/or target motion. The above or other shooting related sport challenges may be performed on a full or partial range and/or using a firing range or target simulator of the multi-sport facility.

Additionally, alternatively, or combination with one or more of the above, the multi-sport challenge system may include sport challenges related to other sports. For example, the other sport challenges may include volley relates sport challenges such as those related to volleyball, footvolley, sepak takraw, or tennis. For instance, sport challenges may require participants to successfully serve, return, or spike the ball to a target or area. Still other sport challenges may include one or more sport related challenges selected from hockey related sport challenges, e.g., hitting a target with a puck along ice while on skates; pool related sport challenges, e.g., hitting a specified pool shot, combo, breaking a rack while hitting a specified ball or combination of balls into one or more pockets; darts related sport challenges, e.g., hitting a specified location, bull, bullseye, or combination of locations on a dart board to achieve a specified numerical score; climbing related sport challenges, e.g., climbing a climbing wall withing a specified period of time; frisbee golf related sport challenges, e.g., hitting a hole-in-one; and card or cup stacking sports related challenges, e.g., stacking a specified stacking configuration one or more times within a specified period of time; Olympic sports such as track and field, e.g., jumping a specified distance or height, running a specified distance in a specified period of time, hurling a discus or javelin or putting a shot a specified distance.

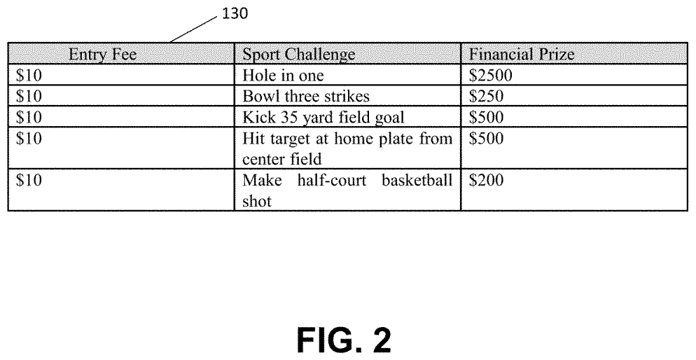

As introduced above, the multi-sport challenge system may include multi-sport challenge wagering. Wagering may include participants wagering on their ability to successfully complete a sport challenge. In various embodiments, participants may pay an entry fee for an opportunity to perform one or more sport challenges for an opportunity to win a financial prize. With reference to FIG. 2, an example menu 130 of selectable sport challenges that may be available to participants of the multi-sport challenge system may include paying a $10 entry fee for the opportunity to make a hole in one with a $2,500 prize, to bowl three strikes in a row for a $250 prize, to kick a 35 yard field goal for a $500 prize, to throw from centerfield to home plate to hit a target for a $500 prize, or to make a half-court basketball shot for a $200 prize.

In the illustrated example, entry fees are shown as being uniform and the prize amounts varied. Additionally or alternatively, different entry fees may be paid for the opportunity to win a uniform amount from a plurality of different sport challenges. Additionally or alternatively, entry fees for the opportunity to attempt particular sport challenges may be the same or different and the financial prize for successful completion of the sport challenges may be the same or different.

The financial prize amount for successful completion of the sport challenge may be fixed prior to or at the time of entry fee payment. In one embodiment, the financial prize may be predetermined based on an entry fee amount. For example, a higher entry fee may be paid to increase the financial prize. In some embodiments, a participant may enter an enhanced sport challenge that changes the requirements for winning the sport challenge in way that increases difficulty or decreases probability of successfully completing the sport challenge to increase the financial prize associated with the sport challenge. Enhancers may be time related, such as an increase or decrease in time in which the sport challenge must be successfully completed. Enhancers may be distance related such as increase or decrease in a distance of an objective of the sport challenge, e.g., a target or target area, goal, basket, or other objective of a sport challenge. Enhancers may be motion related such that an objective of the sport challenge, such as a target, goal, or basket, is in motion during the attempt. Enhancers may be speed related such that a target, ball, or participant must obtain, remain below or above, or maintain a particular speed or range of speed as part of the sport challenge. Enhancers may be series related such that multiple objectives such as targets, goals, or baskets must be hit in series or within a number of attempts. Enhancers may also include a combination of multiple enhancers. Enhancers may increase financial prizes by a predetermined same or different amount as applied to one or more selectable sport challenges. In one example, each enhancer may be associated with a multiplier such as 1.1, 1.5, 2, 2.5, etc., that may be multiplied by a base financial prize associated with a sport challenge to which it applies.

In some embodiments, an entry fee may give a participant more than one attempt to successfully complete the sport challenge. In one configuration, multiple attempts may be available for an increased entry fee or may reduce the financial prize available after each failed attempt.

In one embodiment, a participant may pay an entry fee for an attempt at a same or multi-sport parlay. In one example, the participant may select the sport challenges included in the parlay. In another example, the participant may select a portion or none of the sport challenges included in the parlay. For instance, the participant may select one or more sports associated with available sport challenges from which the challenges will be assigned, e.g., randomly or according to a predetermined schedule. The predetermined schedule may be based on a difficulty rating, for example. In another example, the participant is assigned one or more sport challenges without the opportunity to select the particular challenge. Such assigned sport challenges may award larger financial prizes than those that the participant is able to select.

In some embodiments, entry fee and/or financial prize amounts for particular sport challenges may vary by age, sex, weight, height, or other characteristic of the participant. For example, entry fees may be higher or lower and/or financial prize amounts may be higher or lower for participants older than 30, 40, 50, 60, or 70. Similarly, objectives of particular sport challenges may be varied based on one or more characteristics of the participant. For example, a participant under five feet tall or 50 years old may receive a $1000 prize for throwing to home plate from centerfield and hitting a target while those younger than 50 years old and five feet tall or more may have the opportunity to receive $500 for the same sport challenge.

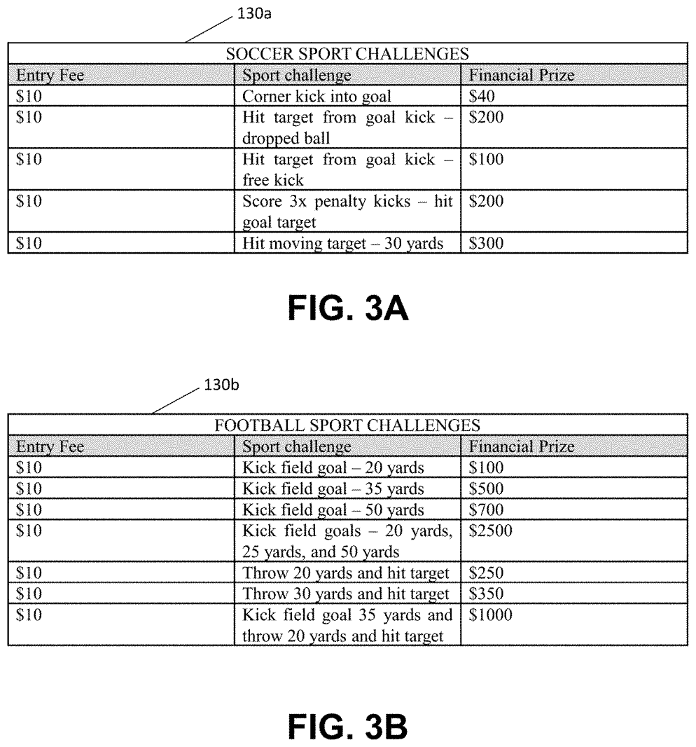

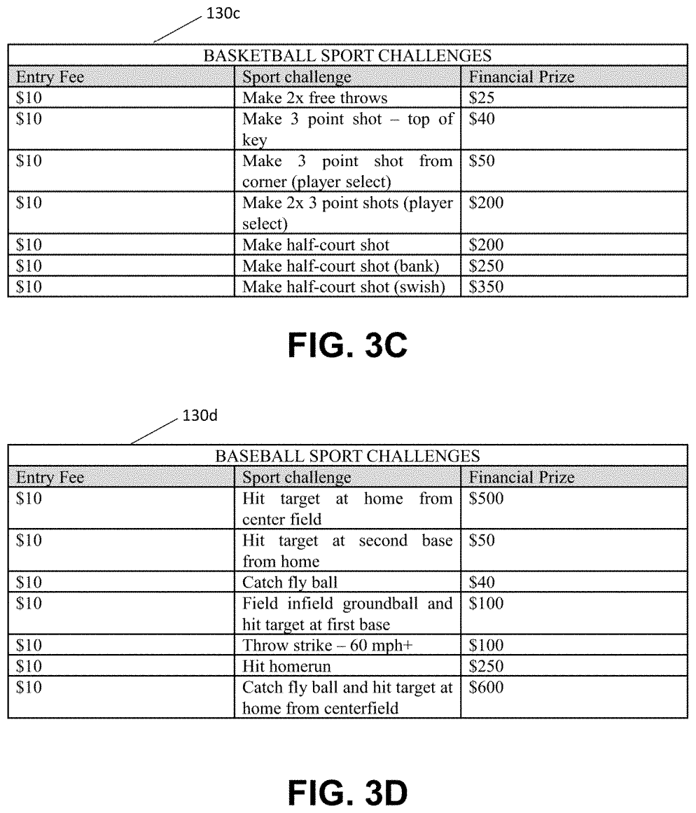

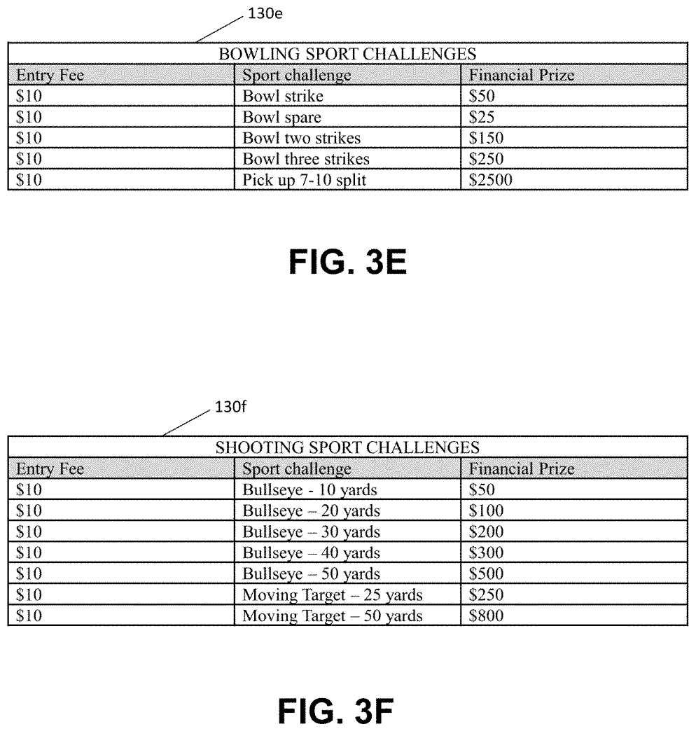

With reference again to FIG. 1 together with FIGS. 3A-3F, the fee/prize subsystem 26 may generate, output, or otherwise provide a sport challenge menu 130 listing sport challenges and associated entry fees and financial prizes that participants may select. FIG. 3A illustrates an example soccer sport challenge menu 130a including plurality of soccer related sport challenges including associated entry fees and financial prizes. FIG. 3B illustrates an example football sport challenge menu 130b including plurality of football related sport challenges including associated entry fees and financial prizes. FIG. 3C illustrates an example basketball sport challenge menu 130c including plurality of basketball related sport challenges including associated entry fees and financial prizes. FIG. 3D illustrates an example baseball sport challenge menu 130d including plurality of baseball related sport challenges including associated entry fees and financial prizes. FIG. 3E illustrates an example bowling sport challenge menu 130e including plurality of bowling related sport challenges including associated entry fees and financial prizes. FIG. 3E illustrates an example shooting sport challenge menu 130f including plurality of shooting related sport challenges including associated entry fees and financial prizes. The sport challenge menus 130a, 130b, 130c, 130d, 130e, 130f are provided for illustration purposes with respect to sports, associated sport challenges, entry fees, and financial prizes. It is to be appreciated that embodiments may include additional, fewer, as well as different sports, associated sport challenges, entry fees, and financial prizes.

Sport challenge menus 130a, 130b, 130c, 130d, 130e, 130f may be displayed as signage with respect to a fee/subsystem building or structure, provided as handout documents to participants, displayed as signage or posted at one or more kiosk stations around the multi-sport facility, displayed as signage or posted at various sport grounds or surrounding portions thereof, e.g., available sport challenges associated with a particular sport grounds may be displayed at or near the associated sport grounds, or may be accessible for display on user electronic devices, e.g., handheld device, tablet, smart phone, or the like.

In one example, the fee/prize subsystem may provide one or more sport challenge menus 130a, 130b, 130c, 130d, 130e, 130f in an interactive environment wherein prospective participants may interact with the sport challenge menus 130a, 130b, 130c, 130d, 130e, 130f to obtain more information regarding the listed sport challenges. For instance, sport challenge menus 130a, 130b, 130c, 130d, 130e, 130f may be displayed on an interactive screen, e.g., kiosk touch screen, or be displayed on a user device, e.g., a smart phone, via a website or app executed or accessed on the user device. If enhancers are available, the sport challenge menus 130a, 130b, 130c, 130d, 130e, 130f may similarly include a list of associated enhancers. In one example, a user may select a desired sport challenge from a sport challenge menu 130a, 130b, 130c, 130d, 130e, 130f via the fee/prize submodule, e.g., interacting with an interactive screen, application, website, or through verbal communication with on-site staff of the fee/prize subsystem.

The fee/prize subsystem may be configured to accept digital fund transfers and/or send digital fund transfers with respect to entry fees and/or financial prizes. The fee/prize subsystem may address or be addressed by user devices via near field, wired, and/or wireless communication networks. Funds may be digitally transferred between a sport challenge account and/or a third party account, such as a digital wallet, e.g., banking app account, GOOGLE WALLET™, GOOGLE PAY®, APPLE PAY®, ALIPAY®, VENMO®, ZELLE®, DWOLLA®, or PAYPAL®.

Further to the above, the fee/prize subsystem may directly or indirectly execute fund transfers with respect to entry fee and financial prize payments. Fund transfers may also be mediated by a third-party fund transfer service. The fee/prize subsystem may be configured to interact with user devices of participants to set up accounts, such as digital wallet accounts, receive payments, make payments, and/or select sport challenges. In one embodiment, participants may set up and fund accounts with the fee/prize subsystem to be used for entry fee payments and/or receiving financial prize fund transfers.

The multi-sport challenge system may include a sport challenge link configured to assist in operation of the multi-sport challenge system. The sport challenge link may include a sport challenge app and/or sport challenge website. The sport challenge link may be utilized to link participants, via user devices, with the fee/prize subsystem. For example, the sport challenge link may be used to link digital, e.g., mobile, payment methods or accounts from which fund transfers may be executed between participants and the fee/prize subsystem. Payment methods and/or accounts may include accounts specific to the fee/prize subsystem, such as a sport challenge account, and/or accounts associated with third-party providers, any of which may include digital wallets. Payment methods may include a digital wallet setup and handled directly with the fee/prize subsystem or a third-party digital wallet such as GOOGLE WALLET™, GOOGLE PAY®, APPLE PAY®, ALIPAY®, VENMO®, ZELLE®, DWOLLA®, or PAYPAL®. to which fund transfers to and/or from participants and the fee/prize subsystem may be mediated.

As introduced above, in some embodiments, participants may establish a sport challenge account with the fee/prize subsystem. Sport challenge accounts may be established, for example, using the sport challenge link, which may include a sport challenge app executed on a user device or via a sport challenge website configured to provide user devices a secure link to the sport challenge account. In one embodiment, a sport challenge account comprises a digital wallet configured for executing fund transfers between the fee/prize subsystem and one or more participant accounts. In some configurations, participants may link their sport challenge accounts to third party fund transfer services and/or digital wallet to transfer funds into and out of their sport challenge accounts. The fee/prize subsystem may address or be addressed by user devices via near field, wired, and/or wireless communication networks to initiate and/or complete fund transfers with sport challenge accounts.

In one embodiment of an operation of the multi-sport challenge system, a participant, using a user device such as a smart phone, smart watch, tablet, or computer, or an on-site user interface such as a kiosk, may view and select one or more sport challenges. If the participant has a sport challenge account linked to the user device or has identified a sport challenge account to the user interface, an entry fee may be withdrawn if indicated by the participant or setup for such autopayment in the user account. In one example, a user may pay cash or credit rather than withdraw the entry fee from their sport challenge account. In a further example, participants may freely choose to pay entry fees with cash or credit and receive financial prizes in cash, credit, or deposit into their sport challenge account. In another example, participants are provided a card or other digital identification technology, e.g., active or passive RFID, BLUETOOTH® low energy technology, IBEACON®, near field, etc., which may also be associated with a user device, that may be detected by a reader or scanner of the fee/prize subsystem to identify the participant. The participant may swipe or merely position their digital identification for proximity reading or scanning for identification to initiate entry fee payment from their sport challenge account. The sport challenge selection and entry fee payment may also link the participant and the sport challenge account for transfer of financial prize funds if the participant successfully completes the selected sport challenge.

In various embodiments, the fee/prize subsystem may also include a participant monitoring unit. The monitoring unit may be configured to monitor participants with respect to adherence to rules applicable to attempts for selected sport challenges. Additionally or alternatively, the monitoring unit may be configured to verify successful completion of attempted sport challenges and/or associate the successful completion of sport challenges to a participant. The monitoring unit may include detection devices such as readers, scanners, or cameras to track and/or identify participants. The detection devices may utilize any suitable identification technology such as digital identification technology, e.g., active or passive RFID, BLUETOOTH® low energy technology, IBEACON®, near field, or recognition technology, e.g., facial, IR, or other biological or physiological recognition technology. Upon verification of successful completion of the sport challenge and identification of the participant by the monitoring unit, the fee/prize subsystem may initiate a fund transfer to an account, e.g., sport challenge account, linked to the participant.

In some embodiments, multi-sport challenge facility staff may one or more of receive sport challenge selections, collect entry fee payments, assist in organizing and/or conducting sport challenge attempts, monitoring participant adherence to rules applicable to attempts for selected sport challenges, verifying successful completion of attempted sport challenges, identification of participants successfully completing attempted sport challenges, or payment of financial prizes.

Additionally or alternatively to providing individual sport challenges in a wagering application, in some embodiments the multi-sport facility may be configured for competing in recreational sport play, rental for group outings, and/or athletic training in specific or multiple disciplines, with or without wagering. For example, the multi-sport challenge system has been described above such that entry fees are placed with the fee/prize subsystem, whereby the multi-sport challenge facility or fee/prize subsystem operates as the house and financial prizes are paid out by the fee/prize subsystem upon successful completion of the sport challenge. However, in some embodiments, the multi-sport challenge system may include sport challenge competition wagering. In one example, two or more participants, which may include two participants or more groups of participants, may pay an entry fee to compete in one or more sport challenges where the participant or participant group having the superior performance is awarded a financial pricing comprising a portion of the combined entry fee. The entry fee will typically be higher than it would be where the fee/prize subsystem operates as the house to payout financial prizes.

In one configuration of the sport challenge competition, the sport challenge may include any sport challenge, such as those described herein, and the participant successfully completing the sport challenge where the other has failed is declared the winner and is awarded the financial prize. In one example, if no participant or participant group successfully completes the sport challenge within the allotted number of attempts, the sport challenge is over and no participant receives a financial prize. In another embodiment, if no participant or participant group successfully completes the sport challenge within the allotted number of attempts, the participants may repeat the same or a different sport challenges until one participant or participant group has successfully completed the repeated sport challenge were the other participants or participant groups have failed. In an above or another example, if multiple competing participants or participant groups successfully completes the sport challenge, those participants or participant groups may repeat the same or a different sport challenge until only one competing participant or participant group has continued to successfully complete the sport challenge to the failure of the remaining participants or participant groups. In a further example, repeated sport challenges increase the difficulty of the sport challenge, e.g., throwing, shooting, or kicking distances to successfully complete the sport challenge may be increased or target may be put in motion or target sizes may be decreased.

In an above or another configuration, sport challenges may be modified to competitive sport challenges such that a participant or participant group is awarded the financial prize for performing the sport challenge to a better degree than the other participants or participant groups, such as proximity to a target or distance may be used. For example, participants may compete in a golf related competitive sport challenge wherein the winner is determined as the closest to the hole or the longest drive. Still another competitive sport challenge may actively pit participants or participant groups against each other. For example, soccer penalty shots may be exchanged wherein the winner is the participant or participant group that scores more penalty goals on the other.

The present disclosure may include dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example network or system is applicable to software, firmware, and hardware implementations.

In accordance with various embodiments of the present disclosure, the processes described herein may be intended for operation as software programs running on a computer processor. Furthermore, software implementations can include, but are not limited to, distributed processing or component/object distributed processing, parallel processing, or virtual machine processing that may be constructed to implement the methods described herein.

The present disclosure describes various systems, modules, units, devices, components, and the like. Such systems, modules, units, devices, components, and/or functionalities thereof may include one or more electronic processers, e.g., microprocessors, operable to execute instructions corresponding to the functionalities described herein. Such instructions may be stored on a computer readable medium. Such systems, modules, units, devices, components, the like may include functionally related hardware, instructions, firmware, or software. For example, modules or units thereof, which may include generators or engines, may include physical or logical grouping of functionally related applications, services, resources, assets, systems, programs, databases, or the like. The systems, modules, units, which may include data storage devices such as databases and/or pattern library may include hardware storing instructions configured to execute disclosed functionalities, which may be physically located in one or more physical locations. For example, systems, modules, units, or components or functionalities thereof may be distributed across one or more networks, systems, devices, or combination thereof. It will be appreciated that the various functionalities of these features may be modular, distributed, and/or integrated over one or more physical devices. It will be appreciated that such logical partitions may not correspond to physical partitions of the data. For example, all or portions of various systems, modules, units, or devices may reside or be distributed among one or more hardware locations.

The present disclosure contemplates a machine-readable medium containing instructions so that a device connected to the communications network, another network, or a combination thereof, can send or receive voice, video or data, and to communicate over the communications network, another network, or a combination thereof, using the instructions. The instructions may further be transmitted or received over the communications network, another network, or a combination thereof, via the network interface device. The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure. The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth in this specification. Such embodiments may be obtained, for example, by combining, modifying, or re-organizing any of the disclosed steps, components, elements, features, aspects, characteristics, limitations, and the like, of the various non-limiting and non-exhaustive embodiments described in this specification.

Various elements described herein have been described as alternatives or alternative combinations, e.g., in a lists of selectable sport challenges, entry fees, financial prizes, sport grounds, etc. It is to be appreciated that embodiments may include one, more, or all of any such elements. Thus, this description includes embodiments of all such elements independently and embodiments including such elements in all combinations.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an application of the described embodiments. Further, the use of a singular noun includes the plural, and the use of a plural noun includes the singular, unless the context of the usage requires otherwise. Additionally, the grammatical conjunctions “and” and “or” are used herein according to accepted usage. By way of example, “x and y” refers to “x” and “y”. On the other hand, “x or y” corresponds to “x and/or y” and refers to “x”, “y”, or both “x” and “y”, whereas “either x or y” refers to exclusivity.

1. A multi-sport challenge system, the system comprising:
a multi-sport facility including a plurality of sport grounds, wherein each of the sport grounds includes a full sports grounds, partial sports grounds, sports simulator grounds, or combination thereof;
a sport challenge menu listing a plurality of selectable sport challenges participants may attempt to perform through interaction with the sport grounds and an entry fee and financial prize corresponding to each sport challenge, the entry fee to be paid by the participant that selects the corresponding sport challenge for an opportunity to attempt to perform the sport challenge, wherein the financial prize is awarded to the participant if the attempt by the participant successfully performs the sport challenge,
wherein the sports grounds includes at least four different types of sports grounds, wherein the different types of sports grounds and corresponding sport challenges are selected from a pitcher's mound and home plate corresponding to a sport challenge comprising the participant throwing one or more pitches over the plate, a bowling lane corresponding to a sports challenge comprising the participant bowling a ball down the bowling lane and striking pins, at least a partial basketball court including a basketball goal corresponding to a sports challenge comprising the participant making one or more specified shots, at least a partial baseball field including an outfield and home plate corresponding to a sports challenge comprising the participant throwing a baseball toward home plate, a par 3 golf hole corresponding to a sports challenge comprising the participant hitting a hole-in-one, an American football uprights and at least a partial football field corresponding to a sports challenge comprising the participant kicking a football through the uprights from a location on the football field, and a soccer goal and at least a partial soccer field corresponding to a sports challenge comprising the participant kicking a soccer ball into the goal; and
a fee/prize subsystem to receive sport challenge selections made by participants and to collect the corresponding entry fees from participants and output corresponding financial prizes upon successful performance of the selected sport challenges.

2. The multi-sport challenge system of claim 1, wherein the sports grounds include the bowling lane, the par 3 golf hole, the at least a portion of a basketball court including the basketball goal, the American football uprights and the at least a partial football field, and one or more sport simulators.

3. The multi-sport challenge system of claim 1, wherein the sports grounds include the par 3 golf hole, the at least a portion of a basketball court including the basketball goal, the American football uprights and the at least a partial football field, and the at least a partial baseball field including a home plate.

4. The multi-sport challenge system of claim 3, wherein the sports grounds further includes one or more sport simulators.

5. The multi-sport challenge system of claim 4, wherein the one or more sport simulators include a golf simulator, shooting range simulator, a soccer simulator, a baseball simulator, or combination thereof.

6. The multi-sport challenge system of claim 5, wherein the sport simulators include a golf simulator, shooting range simulator, a soccer simulator, and a baseball simulator.

7. The multi-sport challenge system of claim 3, wherein the sport simulators include a golf simulator corresponding to a sports challenge comprising the participant landing the ball on the green within a specified distance from the hole, hitting a hole-in-one, or hitting a tee shot of a specified distance or greater.

8. The multi-sport challenge system of claim 1, wherein the sports grounds further include a full or partial tennis court or tennis simulator corresponding to a sports challenge comprising the participant serving a ball to a target location.

9. A multi-sport challenge system, the system comprising:
a multi-sport facility including a plurality of sport grounds, wherein each of the sport grounds includes a full sports grounds, partial sports grounds, sports simulator grounds, or combination thereof;
a sport challenge menu listing a plurality of selectable sport challenges participants may attempt to perform through interaction with the sport grounds and an entry fee and financial prize corresponding to each sport challenge, the entry fee to be paid by the participant that selects the corresponding sport challenge for an opportunity to attempt to perform the sport challenge, wherein the financial prize is awarded to the participant if the attempt by the participant successfully performs the sport challenge,
wherein the sports grounds and corresponding sports challenges comprise:
a bowling lane corresponding to a sports challenge comprising a participant bowling a strike,
a golf hole corresponding to a sports challenge comprising the participant hitting a hole-in-one,
a golf simulator corresponding to a sports challenge comprising the participant landing the ball on the green within a specified distance from the hole, hitting a hole-in-one, or hitting a tee shot of a specified distance or greater,
at least a partial basketball court including a basket corresponding to a sports challenge comprising the participant hitting a half-court shot or a consecutive number of free throws,
a full or partial baseball field corresponding to a sports challenge comprising the participant hitting a target at home from center field, throwing a baseball from a mound for a strike, or throwing a baseball from the mound for a strike above a specified velocity,
American football uprights corresponding to a sports challenge comprising the participant kicking one or more field goals, and
a soccer goal corresponding to a sports challenge comprising the participant kicking a soccer ball into the goal; and
a fee/prize subsystem to receive sport challenge selections made by participants and to collect the corresponding entry fees from participants and output corresponding financial prizes upon successful performance of the selected sport challenges.

10. The multi-sport challenge system of claim 9, wherein the golf simulator corresponds to the sports challenges comprising the participant landing the ball on the green within a specified distance from the hole, hitting a hole-in-one, and hitting a tee shot of a specified distance or greater.

11. The multi-sport challenge system of claim 10, wherein the full or partial baseball field corresponds to the sports challenges comprising the participant hitting a target at home from center field, throwing a baseball from a mound for a strike, and throwing a baseball from the mound for a strike above a specified velocity.

12. The multi-sport challenge system of claim 10, wherein the at least a partial basketball court including the basket corresponds to a sports challenge comprising the participant hitting the half-court shot and a sports challenge comprising the participant hitting a consecutive number of free throws.

13. The multi-sport challenge system of claim 9, wherein the sports grounds further include a full or partial tennis court or tennis simulator corresponding to a sports challenge comprising the participant serving a ball to a target location.
